(19) United States
(12) Patent Application Publication
(10) Pub. No.: US 2006/0017339 A1
(43) Pub. Date: Jan. 26, 2006

(54) Brushless canned motor

(76) Inventors: Lalit Chordia, Pittsburgh, PA (US); John C. Davis, Pittsburgh, PA (US); James Gibbs, Springdale, PA (US)

Correspondence Address: Lalit Chordia, 730 William Pitt Way, Pittsburgh, PA, 15238, US

(21) Appl. No.: 11/145,568

(22) Filed: Jun. 3, 2005

Related U.S. Application Data
(60) Provisional application No. 60/576,742, filed on Jun. 3, 2004.

(51) Int. Cl. H02K 5/00; H02K 5/10; H02K 5/16

(52) U.S. Cl. 310/86; 310/216; 310/40 MM; 310/90

(57) ABSTRACT

The present invention provides a means for constructing a brushless canned motor that is compact enough to be suitable for use in small appliances, such as electronic devices. The rotating parts of the motor are encapsulated within a can such that the motor can be hermetically connected to a driven device.

### CROSS-REFERENCE TO RELATED APPLICATION

This application claims priority from the United States provisional patent application of the same title, which was filed on Jun. 3, 2004 and was assigned U.S. patent application Ser. No. 60/576,742, teachings of which are incorporated herein by reference.

### BACKGROUND OF THE INVENTION

Sealing the motor driver with the driven device through the use of a non-magnetic enclosure, also referred to as a motor can, is a common means of establishing a hermetic barrier between rotating members of the motor and stationary electrical components such as the stator, magnetic return and motor-control circuitry. Said motor can occupies much of the air space that normally exists between the motor's rotor and stator.

Numerous examples of motor cans can be found in the patent literature. A typical application is for the absolute containment of hazardous pumped fluids, such as water, that are exposed to radioactive material at nuclear power plants or on board submarines. The motor windings themselves are bathed and cooled by the pumped fluid, with special precaution to prevent particles from entering the area of the stator. However, it is not always wise to bathe the windings with the pump fluid. Such pumps are usually centrifugal in nature and they can be very large.

Another example is in axial-flow pumps wherein the motor is mounted on the propeller hub, such as Campen et al. (U.S. Pat. No. 5,494,413). Axial flow pumps serve well in large in-line pumping applications, but they are inefficient in low-flow situations.

Cans are also employed with a primary objective of replacing shaft seals in pumps. In canned pumps, high torque and good speed control are ensured because the motor exerts rotational force directly on the impeller shaft, as opposed to indirectly, by means of a magnetic coupling. An example can be found in Kech et al. (U.S. Pat. No. 6,365,998), which describes a centrifugal pump with a rotor consisting of permanent magnets mounted on the impeller shaft together with an electrically-commutated, wound stator that is mounted on a motor can that occupies the air-gap between the rotor and stator. The term “electrical commutation,” as used herein, means the periodic shifting of electrical potential from one coil to another, so as to maintain a continuous rotation of potential about the rotor. Besides shielding the stator and electronics from the pumped fluid, the can serves to hold shaft bearings in place. A common feature found in Kech and many other canned motors is the use of a laminated stack that surrounds the stator and which provides a path for completing the magnetic circuit of the motor. Said magnetic returns are typically comprised of thin stacks of ferromagnetic material that have been individually coated with an electrical insulator. Such stacks provide a magnetic return without generating excessive internal eddy currents that would otherwise dissipate electrical power in the form of heat. The disadvantage of stacked laminations, however, is that they are cumbersome to manufacture and assemble. Applications for canned motors exist in other types of fluid transport devices, particularly mixers, compressors and valves.

It should be emphasized that motor cans can take one of two fundamental configurations: (1) a cylindrical housing around a shaft-mounted rotor, or (2) an annular chamber in which the stator is positioned inside of a spinning magnetic barrel, with a serpentine can maintaining the separation of the barrel and the shaft onto which it is mounted, from the stator. In the first case, henceforth referred to as the “centered rotor” case, the rotor spins within the confines of the stator, but in the second case, henceforth referred to as the “barrel rotor” case, it spins outside of the stator. In both cases, it is the stator that is electrically commutated. An example of barrel rotors is found in Kramer (U.S. Pat. No. 4,890,988). Such rotors are common in spindle motors for such applications as fans and disk drives, where torque requirements are low. In high torque applications, however, the inertial forces needed to start up the motor can be excessive.

Although motor cans are widely known in the art, they are typically used in applications where the motor is large in size. Additionally, canned motors have not been constructed where the electronic circuitry for control of the motor does not require the need for commutation brushes. The present invention addresses both of these issues by constructing a brushless canned motor that is relatively small in size.

### BRIEF SUMMARY OF THE INVENTION

The present invention discloses and electric motor comprising the following elements: (i) a non-magnetic enclosure that envelopes the rotating shaft, bearings, bearing bushings and permanent-magnet rotor; (ii) a stator that is mounted outside the non-magnetic enclosure and; (iii) electronic circuitry for control of the motor without the need for commutation brushes.

### DESCRIPTION

Motors that incorporate a non-magnetic enclosure, such as a can, according to the present invention may include all or some of the following features: (1) bearings, which may be composed of corrosion-resistant elements, that are placed on the motor shaft and held in place by specific contours of the motor can itself; (2) a permanent magnet in the form of either a rotating, centered rotor within the boundaries of the stator, or a rotating barrel that, while attached to the shaft, envelopes the outer boundaries of the stator; (3) in the case of a permanent magnet that rotates within the boundaries of the stator, a component that fits into the magnetic return flux path to the rotor, said component taking the form of a casing of encapsulated magnetic or cooling fluid that surrounds the stator winding or a rotating element; (4) a shaft composed of magnetic material that supports the rotor and bearings and; (5) electronic control circuitry, all of which resides outside of the can. In all cases, the permanent magnet, bearings and shaft rotate together inside the can, which may be sealed to the case surrounding the driven apparatus.

Therefore, in a preferred embodiment, the present invention comprises: a non-magnetic enclosure that envelopes the rotating shaft, bearings, bearing bushings and permanent-magnet rotor; a stationary coil of magnet wire, called the stator, that is mounted outside the non-magnetic enclosure and; electronic circuitry for control of the motor without the need for commutation brushes.

The novel features of this configuration are that all electronic coils, circuitry and attendant commutation controls are located outside of the can, and, as such, protected from fluids that might be present inside of the can. The can occupies a space that is no more than 90% of the air gap that would otherwise be present between the stator and the rotor. It should be composed of material that is strong mechanically, but also is a weak conductor of electrical current. Otherwise, eddy currents that develop within the can would dissipate excessive amounts of power as heat. An example of such a material is titanium. This then allows for continuous operation of the motor which is not possible when a material that is a good conductor of electricity, such as stainless steel, is used. Additionally, the magnetic return, if employed, is likewise positioned wholly outside the can so as not to necessitate any breach in the can in order to control its movement, or the movement of magnetic fluids contained therein.

Separation of the stator and rotor by means of a can is possible by configuring it as a brushless motor, which may be commutated electronically with Hall sensors or in sensorless fashion, according to established art for brushless permanent-magnet motors. The absence of brushes for mechanical commutation, rather than electronic commutation, improves the longevity of the device because thin, delicate brushes are not exposed to fluid coming from the driven member. The can is open to the interior contents of the driven device. In the case of a pump, this means that the fluid being pumped may come in contact with the bearings, rotor magnet, shaft and interior wall of the can.

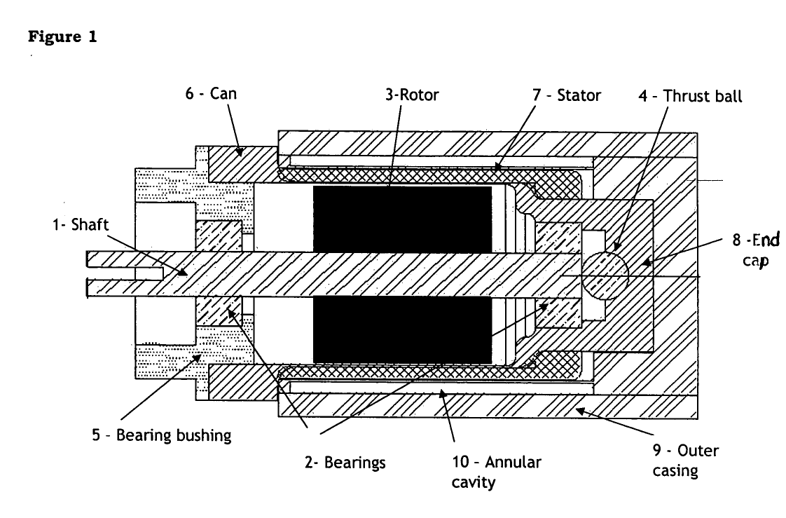

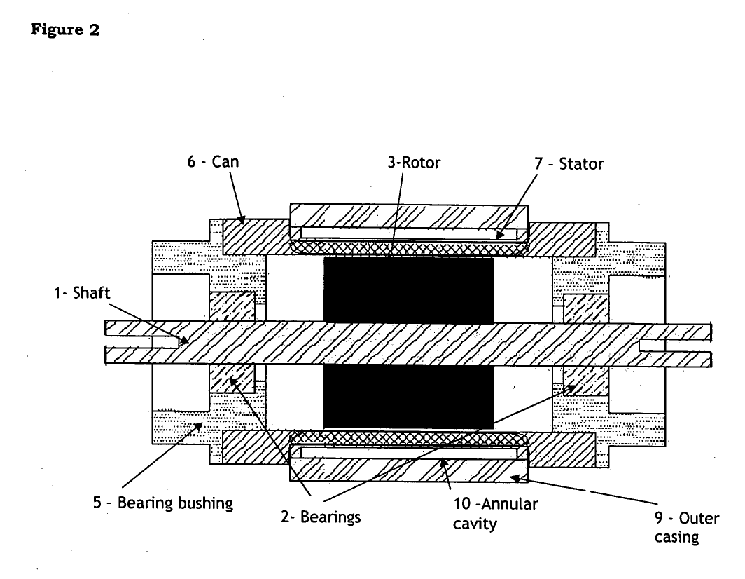

FIG. 1 illustrates an embodiment of the present invention of the components for a centered-rotor configuration. On the axial shaft (1) are mounted two bearings (2) and the permanent rotor (3). The shaft (1) is constrained from moving in an axial direction by means of a thrust ball (4) at one end and a bearing bushing (5) at the end that connects to the driven apparatus. In another embodiment, the thrust ball (4) may be substituted with some other type, such as a thrust bearing, so long as the component achieves the same objective as the thrust ball (4), which is to constrain the shaft from axial movement. The bearing bushing (5) opens directly to the interior of the driven apparatus, which can be a pump in one embodiment. Fluid from the driven apparatus can pass between the forward bearing (2) and shaft (1) and in this way enter the cavity occupied by the rotor (3), rear bearing (2) and thrust ball (4). In another embodiment of the present invention, if an alternative bearing to the thrust ball (4) is employed, it may be possible to configure the can so that it is open to the opposite end, where another hermetic pump or another stage of the first hermetic pump may be positioned, as shown in FIG. 2. Both pumps or pump-stages would be driven by the same motor. In such cases, fluid from one pumping chamber is free to circulate through to the opposite pumping chamber. The bearings (2) may be constructed from the group consisting of corrosion-resistant ceramic balls or other rolling elements, plastic composite sleeves, or some other corrosion-resistant construction known to the art of bearings technology. The bearing bushing (5) may be constructed from the group consisting of ceramic materials, polymeric materials, or a combination thereof. The rotor material may be selected from the group consisting of samarium cobalt, neodymium-iron-boron permanent magnets, other materials suitable for this application or a combination thereof.

Surrounding the aforementioned rotating components is the motor can (6). This can is contoured so as to support the bearings (2) and thrust ball (4) or thrust bearing. It slips securely onto the bearing bushing (5), to which it is hermetically sealed. The can (6) is machined or drawn to a thin cross-section along the longitudinal section that comes between the rotor (3) and stator (7) winding. The thickness of the can (6) in this section should be as small as possible so as to minimize the gap distance between the rotor (3) and stator (7), and is typically less than 7% of the inner diameter of the stator (7) and preferably less than 4% of said inner diameter. A small air gap is left between the spinning rotor (3) and the can (6) so as to ensure that no contact occurs between these two members. As a general rule, the thickness of this air gap is less than the thickness of the can in this section, but it may be larger by a factor of 2 times the can thickness. The stator (7) is mounted directly onto the can (6), with little or no gap.

Not shown in FIG. 1 are wires that connect the stator winding to electronic commutation controls. The number of wires depends on the number of stator phases designed into the coil. The wires extend to the outside by means of small holes drilled into the end cap (8) and onto a controller, which may take the form of a microchip that is attached integrally to the motor on the back of the end cap (8). Lead wires for powering the motor attach directly to said controller. While this configuration represents one way to connect the stator winding to the electronic commutation controls, there are numerous other ways to accomplish the same result, all of which are embodied in the present invention.

In one embodiment, the end cap (8) attaches to the end of the can (6) and may connect with an outer casing (9). This casing, if employed, may contain an annular cavity (10). In a preferred embodiment of this invention, the cavity (10) is filled with a magnetic fluid that is free to rotate within the confines of the annular space. In another embodiment, the cavity (10) may be filled with a fluid that flows into, around and then out of the annular cavity, for the purpose of cooling the stator. Magnetic fluids provide a path for completing the magnetic circuit of the motor, but because magnetic particles in the fluid are separated by non-conductive liquid media, they do not provide paths for electrical conductivity, with resultant generation of internal eddy currents that would dissipate power as heat. Alternatively, the magnetic or cooling fluid, including the casing that would otherwise contain it, can be omitted, in which case the magnetic circuit is completed in air. The advantage of using the magnetic fluid is that motor torque is improved.

A magnetic fluid chosen for this device may be any of several types known in the field of magnetic lubricants. The important characteristics of the fluid are that it is of low viscosity so that it can flow easily inside the annular cavity, electrically non-conductive, and exhibits a magnetic saturation value that is high enough to ensure its effectiveness in improving motor torque. In one embodiment of the invention, the viscosity would be less than 200 cP and the magnetic saturation value would be greater than 50 Gauss. Magnetic saturation is defined as a property of the magnetic material, in this case a fluid, for which increases in magnetic flux in the vicinity of the material do not result in significant increases in magnetic flux through the material. In the preferred embodiment of this invention, the viscosity is less than 100 cp and the magnetic saturation is greater than 100 Gauss.

Non-magnetic cooling fluid, if employed in place of a magnetic fluid, should exhibit the same viscosity characteristics, namely less than 200 cP and preferably less than 100 cP.

In the alternative double-ended configuration, shown in FIG. 2, there are several differences from the above-mentioned description. First, no thrust ball (4) is possible or in fact necessary. Instead, it is replaced with a mirror version of the bearing-and-bearing-bushing assembly that is used at the opposite end of the rotor. Second, the end cap (8) is not present.

In another embodiment of the present invention, a further modification, which is possible with either the single-end or double-end configuration, is to omit the casing completely. In order to protect the stator from exposure to the outside environment and possible rough handling, the stator should be encapsulated in a plastic compound, such as an epoxy potting compound. When this is practiced, the potted stator becomes the protective casing for the motor. This configuration should actually be stronger and provide more protection from clamping forces, which might otherwise crimp the motor can, due to the fact that the stator and plastic compound form a reinforced plastic composite.

All parts that are not essential to the magnetic circuit, which include the bearings, bearing bushing, thrust ball, can, end cap and outer casing, should be of a non-magnetic material, such as non-magnetic grades of stainless steel or synthetic polymers. The rotor and return fluid must be magnetic. Additionally, the shaft and rotor must be coated to protect them from corrosion, or preferably the rotor is a corrosion-resistant permanent magnet, or a magnet that is plated with a film of corrosion-resistant material.

The present invention also provides a means for a brushless canned motor that is small in size but can still withstand a substantial amount of pressure. In one embodiment, the diameter of the can is 10 mm, with a wall thickness of 0.127 mm. In this configuration, the can is able to withstand pressures of up to 700 psi. However, at a higher wall thickness, the amount of pressure the can withstands dramatically increases. In another embodiment, the diameter of the can is 25.4 mm.

The above-provided discussion of various embodiments of the present invention is intended to be an illustrative, but not exhaustive, list of possible embodiments. It will be obvious to one skilled in the art that other embodiments are possible and are included within the scope of this invention.

We claim:

1. An electric motor comprising the following elements:
a) a non-magnetic enclosure that envelopes the rotating shaft, bearings, bearing bushings and permanent-magnet rotor;
b) a stator that is mounted outside said non-magnetic enclosure and;
c) electronic circuitry for control of said motor without the need for commutation brushes.

2. An electric motor as in claim 1 wherein a casing envelopes said stator and contains an annular cavity.

3. An electric motor as in claim 2 wherein said annular cavity contains a fluid.

4. An electric motor as in claim 3 wherein said fluid is magnetic.

5. An electric motor as in claim 1 wherein the non-magnetic enclosure is constructed of a material that conducts a minimal amount of electricity.

6. An electric motor as in claim 1 wherein said bearings are composed of material selected from the group consisting of ceramic materials, polymeric materials and a combination thereof.

7. An electric motor as in claim 1 wherein said bearing bushings are composed of material selected from the group consisting of ceramic materials, polymeric materials and a combination thereof.

8. An electric motor as in claim 1 wherein said rotor material is selected from the group consisting of samarium cobalt, neodymium-iron-boron permanent magnets, other materials suitable for said rotor and a combination thereof.

9. An electric motor as in claim 8 wherein said rotor material provides corrosion protection.

10. An electric motor as in claim 1 wherein said rotor is of a centered rotor type.

11. An electric motor as in claim 1 wherein said non-magnetic enclosure is connected hermetically to a driven apparatus.

12. An electric motor as in claim 1 wherein said non-magnetic enclosure is connected hermetically to a pair of driven apparatuses positioned at opposite ends of said non-magnetic enclosure.

13. An electric motor as in claim 3 wherein fluid circulating in said annular cavity has a viscosity of less than 200 cP.

14. An electric motor as in claim 1 wherein said stator is potted in a plastic compound.

15. An electric motor as in claim 1 wherein said shaft is constrained from moving in an axial direction by said bearing bushing at one end and a thrust ball at the other end.

16. An electric motor as in claim 15 wherein said thrust ball is substituted with a thrust bearing.

17. An electric motor as in claim 1 wherein said non-magnetic enclosure is less than 7% of the inner diameter of said stator.

18. An electric motor as in claim 1 wherein said stator is mounted directly onto said non-magnetic enclosure.

19. An electric motor as in claim 1 wherein wires connect said stator to said electronic circuitry.

20. An electric motor as in claim 1 wherein the outer diameter of said non-magnetic enclosure is less than 25.4 mm.

21. An electric motor as in claim 1 wherein said non-magnetic enclosure can withstand pressures up to 700 psi.
